(19) United States
(12) Patent Application Publication
(10) Pub. No.: US 2025/0367803 A1
(43) Pub. Date: Dec. 4, 2025

(54) POWER TOOL WITH PARALLEL OUTPUT AND MOTOR AXES

(71) Applicant: Hilti Aktiengesellschaft, Schaan (LI)

(72) Inventors: Martin SCHAEFER, Schwarzach (AT); Stefan RINGLER, Schwabmuehlhausen (DE); Christian SATTLER, Biessenhofen (DE); Stefan HÖSSLE, Augsburg (DE)

(21) Appl. No.: 18/867,432

(22) PCT Filed: May 26, 2023
(86) PCT No.: PCT/EP2023/064239

§ 371 Date: Nov. 19, 2024

(30) Foreign Application Priority Data
Jun. 7, 2022 (EP) 22177445.8

(51) Int. Cl. B25D 11/00; B25D 17/28; B25F 5/02

(52) U.S. Cl. CPC B25D 11/00; B25D 17/28; B25F 5/02

(57) ABSTRACT

A power tool having a tool which can be driven by a shaft device and a motor, wherein a position of the shaft device is defined by a shaft axis A1 and a position of the motor is defined by a motor axis A2, wherein the power tool is connectable to at least one exchangeable energy supply device in order to be supplied with energy, and the shaft axis A1 runs substantially parallel to or collinearly with the motor axis A2.

The present invention relates to a power tool having a tool which can be driven by a shaft device and a motor.

### BACKGROUND OF THE INVENTION

Drills, in particular core drills, with which substantially cylindrical drill cores can be cut out of a substrate are known, for example, in the field of power tools. Core drills have, for example, drill bits as tools that can be driven by the core drill to perform a rotary movement.

### SUMMARY OF THE INVENTION

Up to now in the prior art, in particular mains-operated core drills which draw their energy from a power grid, have been known. Said power grid may be, for example, a public power grid or a construction site power grid. However, a disadvantage of the known mains-operated core drills is that they are often inconvenient to handle because of the wiring. In addition, the power cord is often “in the way,” and therefore it even represents a safety risk in some cases. Another safety risk can arise from the interaction of electricity with cooling or rinsing water used while carrying out a core drilling operation. Moreover, the operation of such a mains-operated core drill is possible only in those areas of a construction site where electrical energy is available in the form of a mains connection. Another disadvantage of power cords is that they frequently become damaged. For example, they may become jammed or damaged during drilling. As a result, they can represent a safety risk for the power tool itself or for the user.

The drills known from the prior art can either be held by a user (“hand-held”) or fastened to a drill stand during operation (“stand-guided”). There are devices that are intended for both types of use (universal drills) and devices that can be operated only in a hand-held or stand-guided manner. The drills which may at least also be stand-operated frequently have an interface for connecting the device to a drill stand.

In mains-operated drills, as are known from the prior art, said drill stand interface is frequently found on the underside of the drill. However, this arrangement of the drill stand interface on the underside of the drill can make handling the power tool more difficult, especially if the drill is designed as a battery-operated drill. Due to the positioning of the battery, a greater distance may be required between the drill stand interface and the drill stand. The greater distance between the drill stand interface and the drill stand may disadvantageously reduce the rigidity of the system consisting of the drill stand and the drill, or accessory material which is already present may not be used further.

In addition, it would be appreciated by those skilled in the art if the user could be instructed in the use of the power tool or could receive instructions in order to enable optimal operation of the power tool.

It is an object of the present invention to overcome the above-described deficiencies and disadvantages of the prior art and to provide a power tool that can be used particularly flexibly, conveniently and safely on a construction site. The power tool should be easy and uncomplicated to use in all areas of a construction site. In addition, it would be appreciated by those skilled in the art if the power tool to be provided could be particularly compact and handy, so that even long-lasting work with the power tool is perceived by a user as being not particularly strenuous.

[symbol]

According to the invention, a power tool having a tool is provided. The tool may be driven by a shaft device and a motor, wherein a position of the shaft device is defined by a shaft axis A1 and a position of the motor is defined by a motor axis A2. The power tool may be connected to at least one exchangeable energy supply device in order to be supplied with energy, wherein the shaft axis A1 extends substantially parallel to or collinearly with the motor axis A2. Preferably, the shaft device having the shaft axis A1 can be referred to as an “output shaft” and the shaft device having the motor axis A2 can be referred to as a motor shaft. As a result, the power tool can be referred to preferably as a “power tool having substantially parallel output and motor axes”. The motor axis A2 defines preferably the position or arrangement of the motor within the power tool. The exchangeable energy supply device may be in particular a rechargeable battery or a storage battery, wherein the power tool draws its energy from the at least one exchangeable energy supply device. For example, the power tool may have one or two exchangeable energy supply devices. The energy supply devices are exchangeable in that an “empty” battery can be removed from the power tool in order to be recharged—for example in a charging device. In place of the “empty” battery, a “fresh” battery, i.e. a fully charged battery, can be inserted into the power tool in order to ensure the energy supply of the power tool. As a result of the power tool being supplied with electrical energy by an exchangeable energy supply device, several advantages are achieved. Firstly, the power tool can be used particularly flexibly, since its operation is not dependent on the presence of a grid connection. Furthermore, safety during operation of the power tool is substantially increased since there are no power cables acting as “trip hazards”. Furthermore, potential sources of danger, such as damaged cables, which come into contact with cooling or rinsing water, are eliminated in that it is possible to dispense with a power cable in the case of the power tool having the exchangeable energy supply device.

It is preferred in the context of the invention that the power tool has a device for receiving the at least one exchangeable energy supply device. The device for receiving the at least one exchangeable energy supply device is preferably a receiving device or interface, which can preferably also be referred to as an “energy interface” in the context of the invention. The energy interface is preferably inside the power tool, and therefore it is not illustrated in the figures.

It can also be preferred in the context of the invention that the exchangeable energy supply device is designed as a mains adapter. The term “mains adapter” is understood in the context of the invention as a device that enables the energy supply of the power tool, which is battery-operated per se, through a power grid. The shape of the mains adapter can be similar to that of a battery and can fit into the energy interface of the power tool. In other words, the energy interface of the power tool can be configured to receive rechargeable batteries and/or mains adapters. The mains adapter also has a power cable for connecting the mains adapter to a power grid. If it turns out during operation of the power tool that the battery of the power tool is “empty”, the battery can be removed from the power tool and replaced with the mains adapter. The mains adapter advantageously ensures the energy supply of the power tool, with the mains adapter being available in particular as an “emergency reserve” or “fallback option” should the energy reserve of the battery of the power tool be used up surprisingly quickly or if the battery is defective or is unusable in some other way. The mains adapter can also be used, for example, when a relatively large number of core drilling operations are to be carried out, for which the energy of one or more batteries is not sufficient. The mains adapter can therefore contribute to increasing the range of the power tool, while an energy supply device in the form of a battery, for example, can contribute to providing a power tool that can be used particularly flexibly.

It is preferred in the context of the invention that the power tool comprises a first housing and a second housing, the first housing being configured to at least partially enclose the motor, and the second housing being configured to at least partially enclose the exchangeable energy supply device. Due to the two-part nature of the housing, the power tool components contained in the individual housings, such as the energy supply device or motor, can be particularly well protected from damage, dust or moisture. The first housing is preferably also referred to as a “motor housing”, while the second housing can be referred to as a “battery housing”. The provision of the two housings makes it possible to provide particularly good protection for the individual components of the power tool. As a result, a service life of the power tool or a maintenance interval between two maintenance processes can advantageously be extended. It is preferred in the context of the invention that the device for receiving the at least one exchangeable energy supply device is arranged in the second housing of the power tool. In other words, the energy interface of the power tool can be present in the battery housing.

The position of relevant components of the power tool can be defined or described by imaginary axes. For example, the position of the motor within the power tool can be described by a motor axis A2. Preferably, the motor of the power tool may comprise a motor shaft, wherein the motor axis A2 extends through the motor shaft. The motor may preferably be in the form of an electric motor and generate a rotary movement which can be transmitted via the motor shaft and/or the shaft device of the power tool to the tool of the latter. The position of the shaft device or of the output shaft of the power tool is described by a shaft axis A1. In the context of the invention, it is preferred for the shaft axis A1 and/or the motor axis A2 to be arranged in a forward/rearward direction of the power tool. As a result, the shaft axis A1 and the motor axis A2 extend substantially parallel to or collinearly with one another. Preferably, the position of the tool of the power tool can also be described by means of the shaft axis A1, since the tool is able to be connected to the shaft device in order to be driven. As a result of the arrangement of the motor, of the shaft device and of the tool of the power tool with respect to one another, a particularly compact power tool that is easy to handle can be provided. The power tool may in particular have a short design, which allows in particular good attachability to a drill stand. The wording “substantially parallel or collinear” is not an unclear concept to a person skilled in the art because a person skilled in the art knows that axes that are substantially parallel or collinear may have slight deviations from mathematically exact parallelism or collinearity, which may be brought about for example by the production process. Such deviations may lie for example in a range of +/−5°.

For example, the power tool may provide a power of more than 1 kW.

In the context of the invention, it is preferred for the energy supply device to be insertable into the power tool along an insertion direction E. For example, the power tool may have a cavity into which the energy supply device can be introduced. On the top side of the energy supply device, an interface may be provided, via which the energy supply device can be connected to the energy interface of the power tool. Of course, the interface for connecting the energy supply device to the energy interface of the power tool may also be arranged on a side face or a rear face or a front face of the energy supply device.

For example, the insertion direction E may be oriented substantially parallel to the shaft axis A1 and/or to the motor axis A2. In this preferred configuration of the invention, the insertion direction E—together with the shaft axis A1 and/or the motor axis A2—may be arranged in the forward/rearward direction of the power tool. In particular, the power tool may have on its rear side an opening, wherein the energy supply device can be introduced into a cavity in the power tool through the opening. In the process, the energy supply device is pushed in the spatial direction “toward the front V” such that the insertion direction E in this case coincides preferably with the orientation of the spatial direction “toward the front V”. Examples of an energy supply device that can be introduced into the power tool from behind are shown in FIGS. 3, 4 and 6.

In another configuration of the invention, the insertion direction E may be oriented substantially perpendicularly to the shaft axis A1 and/or to the motor axis A2. In this embodiment of the invention, the energy supply device may be introduced preferably transversely into the power tool. This preferably means, in the context of the invention, that the insertion direction E can extend from a right-hand side of the power tool to a left-hand side of the power tool, or vice versa. In this configuration of the invention, the power tool may have, on its right-hand or left-hand side, an opening into which the energy supply device can be introduced. Since the energy supply device is introduced transversely into the power tool, a particularly short, compact and as a result particularly handy power tool can be provided. Examples in which the energy supply device can be introduced transversely into the power tool are shown in FIGS. 7 to 9.

It is preferred in the context of the invention that the power tool has at least one sensor for detecting a connection state of the power tool to a drill stand. The power tool is preferably configured by means of the sensor to detect whether the power tool is mounted on a drill stand. For example, when the power tool is mounted on the drill stand, the sensor can send an installation signal to the power tool when the power tool is attached to the drill stand. Alternatively or additionally, the sensor can send a removal signal to the power tool when the power tool is removed from the drill stand. The provision of the sensor can advantageously enable direct drill stand detection, in which it is determined, preferably without detours or auxiliary variables, whether or not the power tool is arranged on a drill stand. The states “power tool is mounted on the drill stand” and “power tool is not mounted on the drill stand” are preferably referred to as connection states of the power tool in the context of the invention. The sensor may preferably be, but is not limited to, a mechanical switch, a proximity sensor, and/or an optical sensor, such as a light sensor. In the context of the invention, it is very particularly preferred that the sensor is configured to preferably automatically send a first or installation signal when the power tool is mounted and also preferably automatically a second or removal signal when the power tool is removed. The signals can be sent, for example, to the power tool or to a control device of the power tool, with the signals from the power tool advantageously being able to be used to set an operating mode of the power tool. In other words, an operating mode of the power tool can be set depending on a connection state of the power tool. For example, a drill stand operating mode, in which the power tool can operate at higher operating forces than in a hand-held operating mode, can be provided. If the power tool is designed as a drill, in particular as a core drill, the drilling or pressing forces with which the tool of the power tool, preferably a drill bit, is pressed onto the substrate to be worked can be significantly higher in the drill stand operating mode than in the hand-held operating mode. For example, drive parameters of the power tool can be selected or set differently depending on the preferably automatically set operating mode of the power tool. Drive parameters can be, for example, rotational speeds of the tool of the power tool or of the motor of the power tool, torques or other operating parameters that have an effect on the operation of the power tool. In another exemplary embodiment of the invention, a motor characteristic can be selected or set depending on the connection state of the power tool. The motor characteristic can preferably also be set or selected depending on a diameter of the tool used or on a diameter of the bore to be drilled. In other words, the motor characteristic of the power tool can be set depending on a connection state of the power tool and/or depending on a diameter of the tool and/or the bore to be drilled. The motor characteristic preferably indicates a relationship between a speed of the motor of the power tool and a torque.

Advantageously, the sensor can be influenced only with difficulty or by means of aids in order to avoid direct drill stand detection or to prevent signal transmission. The operation of the power tool can thus virtually not be manipulated. In addition, a display on a display device, such as a display, can vary depending on the operating mode. The term “operating mode” means, for example, whether a drill stand is detected or not. In this way, different recommendations can be issued to the user of the power tool. These recommendations can relate, for example, to the contact pressure with which the power tool is pressed onto the substrate to be worked. The recommendation for an application-optimized contact pressure can vary in the context of the present invention, depending on whether the power tool is arranged on a drill stand or is operated manually.

The provision of such a sensor is particularly advantageous when the power tool is a universally usable power tool which can be operated, for example, both in operation on a stand and when hand-held.

In a further exemplary embodiment of the invention, switch-on or start-up characteristics of the motor of the power tool can be selected or set depending on the connection state of the power tool. In the context of the invention, this preferably means that the starting-up of the power tool after it has been switched on can be varied depending on the set or automatically detected connection state of the power tool. For example, the power tool can start up more gently in the hand-held connection state than in the drill stand connection state.

If the power tool is arranged on a drill stand, the drilling feed can be brought about by an automatic feed device. It is preferred in the context of the invention that different operating parameters of the power tool can be set, depending on whether such an automatic feed device is used or not. It may also be preferred in the context of the invention that the feed of the power tool is brought about by a handwheel.

The power tool can also comprise a display device, for example, on which information for the user of the power tool can be displayed. It is preferred in the context of the invention that different information can be displayed on the display device, depending on which operating mode is specifically set at the power tool. In other words, the information displayed on the display device can be selected depending on the connection state of the power tool. For example, in the respective operating mode of the power tool, information instructing the user to press the power tool onto the substrate with an optimal contact pressure can be displayed on the display device. It may also be preferred in the context of the invention that different drilling performance information is displayed, depending on whether the power tool is operated in the drill stand operating mode or in the hand-held operating mode. In addition to information relating to the use of the power tool, information about a charge state of the exchangeable energy supply device, for example a battery, of the power tool can also be displayed on the display device, for example.

It is preferred in the context of the invention that the power tool has a drill stand interface for connecting the power tool to a drill stand. This can advantageously ensure a fixed, secure and particularly stable fastening of the power tool to the drill stand.

In one exemplary embodiment of the invention, the drill stand interface can be arranged on an underside of the power tool. An overview of the “up”, “down”, “front” and “rear” spatial directions is shown in the figures. In this preferred configuration of the invention, the underside of the power tool represents the side of the power tool that faces the drill stand. In this way, an improved connection of the preferably battery-operated power tool to the drill stand can advantageously be made possible. In addition, a preferably purely stand-guided, battery-operated power tool can be provided in this way. As a result, in particular, a particularly compact and handy power tool which is optimized for drill stand operation can be provided. In particular, by providing the drill stand interface on the underside of the power tool, a particularly short distance between the shaft device or the tool of the power tool and the drill stand can be achieved, which has proven to be advantageous for the operation of the preferably stand-guided, battery-operated power tool. In addition, the arrangement of the drill stand interface on the underside of the power tool allows good accessibility to the individual components of the power tool and good visibility of the display device.

In the context of the invention, it is preferred for the at least one exchangeable energy supply device to be arranged in a continuation of the shaft axis A1 and/or motor axis A2. In the configuration of the invention in which the drill stand interface is arranged on the underside of the power tool, it is preferred in the context of the invention that the first housing and the second housing are arranged at approximately the same height and/or substantially next to one another. For example, the second housing can be arranged in a rear region of the power tool, while a receiving device for the tool of the power tool is present in a front region of the power tool (“tool fitting”). The first housing, in which the motor of the power tool is at least partially arranged, can preferably be arranged between the tool fitting and the second housing. The exchangeable energy supply device is preferably present in a rear region of the power tool in the second housing of the power tool. The battery or mains adapter can be introduced or removed through the rear side of the power tool, and therefore the provision of the drill stand interface on the underside of the power tool can substantially facilitate the introduction and removal of the exchangeable energy supply device. The second housing of the power tool can comprise protective elements which are configured to protect the exchangeable energy supply device when the at least one exchangeable energy supply device is arranged in a continuation of the shaft axis A1 and/or motor axis A2. As a result, particularly effective protection of the energy supply device can be provided with the invention.

It may also be preferred in the context of the invention that the battery or the mains adapter is pushed in from the side into a cavity or a receiving space of the power tool. Also in this configuration of the invention, the provision of the drill stand interface on the underside of the power tool can considerably facilitate the connection of the energy supply device to the power tool.

An advantage of providing the drill stand interface on the underside of the power tool is that this mounting direction does not increase the system width, and therefore accessibility to the corners of the energy supply device is improved.

In a further exemplary embodiment of the invention, the drill stand interface can be arranged on a top side of the power tool. The drill stand interface can preferably also be arranged on a first side wall and/or on a second side wall of the power tool. In the context of the invention, this preferably means that the drill stand interface is arranged laterally on the power tool. It is preferred in the context of the invention that the power tool can be used in a stand-guided and/or hand-held manner. Such power tools, which can be operated both in a stand-guided and hand-held manner, are preferably referred to as “universal power tools” or “universally usable power tools” in the context of the invention. It is preferred in the context of the invention that the universal power tool has a first handle and/or a second handle, it being possible for the second handle to be in the form of a side handle. The first handle can be designed as a D handle, for example.

It is preferred in the context of the invention that the side handle (second handle) of the power tool is rotatable. For example, the side handle of the power tool can be rotated by up to 360°. As a result, the operability of the power tool can be significantly improved, for example for left-handers.

In a further preferred configuration of the invention, the power tool can have a different handle from the first handle, which is designed, for example, as a T handle and may preferably be referred to as a third handle in the context of the invention. Such a T handle may preferably also be referred to as a “pistol grip” in the context of the invention. A power tool can have, for example, a second handle, which is designed as a rotatable side handle, and a T handle. The T handle may preferably be present below the first housing and/or the second housing. For example, the T handle may also be present below a transition region between the first housing and the second housing region of the power tool. Such a power tool is shown in FIGS. 7 and 8, for example. If the housing of the power tool is designed in one piece, the third handle, which is preferably designed as a T handle, can be arranged below said single-part housing. It is preferred in the context of the invention that the third handle is arranged at least partially below the energy supply device. As a result, the third handle can advantageously be located in the center of gravity or in spatial proximity to the center of gravity of the power tool when a wall is being worked with the power tool (horizontal operation of the power tool). This makes it possible to work with the power tool in a particularly comfortable and ergonomically advantageous manner.

With the provision of the third handle, a particularly short design of the power tool, which can also have a particularly low height, can advantageously be made possible. These dimensions make it possible for a power tool that sits ergonomically particularly well in the hand to be provided.

Preferably, the third handle extends along an upward/downward direction of the power tool. A virtual axis can preferably be placed through a center of the third handle, said axis A3 enclosing an angle alpha through the third handle with the shaft axis A1 and/or the motor axis A2, the angle alpha being in a range from 60 to 100°, preferably in a range from 70 to 90° and most preferably 80°. It is preferred in the context of the invention that the energy supply device lies at least partially in this opening angle alpha between the third axis A3 on the one side and the shaft axis A1 and/or the motor axis A2 on the other side. Since the virtual axis A3, which preferably runs through the third handle, encloses two angles with the shaft axis A1 and/or the motor axis A2, which each add up to an angle of 180°, the angle alpha in the context of the invention is defined as the smaller of the two angles. The larger opposite angle (180°—alpha) preferably at least partially encloses the motor of the power tool. While the shaft axis A1 and the motor axis A2 run substantially horizontally when a wall is being worked with the power tool, the third axis A3 runs slightly inclined relative to the wall in this case. If the third axis A3 is theoretically extended beyond the power tool, the third axis A3 preferably encloses an angle with the substrate to be worked, with said angle preferably corresponding to the angle alpha in terms of value. The shaft axis A1 and the motor axis A2 preferably extend substantially along a working direction of the power tool, while the third axis A3 runs inclined with respect to the working direction of the power tool or encloses the angle alpha with the working direction.

The power tool may comprise a display device, which is arranged preferably on a rear side and/or top side of the power tool. The display device represents what may preferably be referred to in the context of the invention as a human-machine interface (HMI). The display device may comprise a display or a small monitor, so that information can be displayed to the user of the power tool. Preferably, the display device may also be in the form of a touchscreen. Furthermore, operator control elements, such as buttons or switches, may be arranged in the spatial vicinity of the display device.

In the context of the invention, it is very particularly preferred for the display device to be arranged in an inclined manner. To that end, an inclined plane, in which the display device may be embedded, may be formed between the top side and the rear side of the power tool. In the context of the invention, the inclined plane may preferably also be referred to as a “display device plane”, wherein the display device plane encloses an angle beta with the shaft axis A1 and/or the motor axis A2. The location and position of angle beta is shown in FIG. 9. In the context of the invention, it is preferred for the angle beta to lie in a range between 20 and 70°. In the context of the invention, the unit “°” corresponds preferably to the angle unit “degrees”. It is preferred in the context of the invention that an angle beta between the inclined display device plane and the output shaft of the power tool is in a range between 20 and 70°. In the context of the invention, the term “output shaft” is used synonymously for the shaft axis A1 of the power tool. With the inclined or obliquely arranged display device, the invention deliberately turns away from the prior art. This is because, in conventional power tools, as they are known from the prior art, such display devices are frequently present in a flat plane on the top side and/or on the rear side of the power tool. This means that such conventionally arranged display devices run substantially parallel to or vertically along the rear side and/or the top side of the power tool. The display device is often oriented here substantially perpendicularly or horizontally to an output shaft of the power tool. As a result of the inclined or oblique arrangement of the display device, a particularly short overall length of the power tool, and a compact design can advantageously be allowed. Furthermore, the height of the power tool can be kept low. As a result, the ergonomics and handling of the power tool can be improved.

Tests have shown that the readability of the display device can be considerably improved when the display device is arranged obliquely or in an inclined manner and not vertically or horizontally. This is because many displays and monitors have a viewing angle dependency such that the displays and monitors cannot be read equally well from any direction and from any position. As a result of the inclined or oblique arrangement of the display device on the inclined plane, which preferably connects the top side of the power tool to its rear side, the reading of the information on the display device can be considerably simplified or made less difficult for the user. This applies in particular under unfavorable weather conditions such as strong sunshine, for example. Furthermore, as a result of the preferably oblique or inclined arrangement of the display device, the power tool can be used equally well horizontally (for example when working on a wall, working direction: “toward the front”) or vertically (for example when working on a floor, working direction: “downward”), since in both working directions, optimal readability of the display device for the user is ensured as a result of the inclined or oblique arrangement of the display device.

It is preferred in the context of the invention that the power tool comprises a protective device for the energy supply device, it being possible for the protective device for the energy supply device to have battery protection elements. The battery protection elements can preferably be in the form of protruding elements or spikes, the height of which is greater than a protrusion of the energy supply device. The battery protection elements can protrude from the housing of the power tool in the manner of stalagmites and have a height. The housing of the power tool, in particular the second or battery housing, can be designed in the manner of a frame or framework, with the energy supply device being able to protrude from openings or clearances in the housing of the power tool. The length of said protrusions is preferably smaller than the height of the battery protection elements, and therefore the battery protection elements can thereby protect the energy supply device particularly well against mechanical damage or impairments. The battery protection elements can be characterized by an inner axis, said axes of the battery protection elements being substantially perpendicular to the housing of the power tool and/or to the substantially flat side surfaces of the energy supply device. The inner axes of the battery protection elements are in particular substantially perpendicular to the shaft axis A1 and/or the motor axis A2 of the power tool. Of course, the battery protection elements are also referred to as battery protection elements if the power tool contains a mains adapter as an energy supply device, instead of a rechargeable battery.

In the context of the invention, it is preferred that battery protection elements are arranged on both sides of the energy supply device. For example, four battery protection elements can be provided both on the left side and on the right side of the energy supply device, with the battery protection elements being configured in particular to protect the particularly sensitive corners and edges of the energy supply device from the effects of the power tool being dropped or falling over. It is preferred in the context of the invention that four battery protection elements are arranged on the left side and/or on the right side.

The protection device for the energy supply device or its battery protection elements are designed in particular as part of the housing of the power tool. If the housing of the power tool consists of a plurality of partial housings, for example a first housing for the motor and a second housing for the energy supply device, the protective device for the energy supply device and its battery protection elements can be designed as part of the first and/or the second housing. The second housing of the power tool is preferably in the manner of a frame or framework such that it preferably does not form a closed housing that completely encloses the energy supply device. Rather, the second housing of the power tool can be an open structure with openings and clearances, and therefore the energy supply device can be viewed from the outside, for example. As a result, material can be saved in the production of the housing or the protective device for the energy supply device, and a particularly lightweight power tool can be provided. In the context of the invention, it is very particularly preferred that the protective device and its battery protection elements are designed as part of the second housing of the power tool.

An accessory device can be provided for the power tool, which accessory device advantageously offers an option for supporting the body of the user of the power tool when hand-held work is being carried out with the power tool. The accessory device can be connected to the power tool, the protective device for the energy supply device and/or the battery protection elements in a particularly simple and uncomplicated manner in the sense of a plug-and-play solution, and therefore the accessory device can be used directly for working with the power tool. The accessory device preferably comprises a soft supporting surface against which the user of the power tool can lean or press when working with the power tool. In addition to the soft supporting surface, the accessory device comprises connecting means with which the accessory device can be connected to the power tool, the battery protection device and/or to the battery protection elements. The connecting means can preferably be latching hooks, guide and connecting rails or the like, without being limited thereto. In this way, the accessory device can be designed, for example, as a latching battery protection accessory device and can be connected with a mounting direction to the power tool or its other battery protection components. For example, the latching hooks can engage with the battery protection elements, as a result of which the accessory device can be fastened to the power tool or the battery protection device.

The accessory device can also comprise a body that connects the supporting surface to the connecting means. It is preferred in the context of the invention that the body can be connected to the battery protection device. This can advantageously be undertaken with the connecting means, which can be formed, for example, by two opposite latching hooks. The accessory device can, for example, comprise plastic or can be formed from plastic in order to have elastic properties or to be elastically deformable within a certain range. For example, the accessory device can be easily compressed when it is to be removed from the power tool or the battery protection device. Compression of the accessory device causes the latching hooks to be released or disengaged from the battery protection elements, so that the accessory device can be easily removed from the power tool or the battery protection device.

The mounting direction of the accessory device can, for example, substantially coincide with the insertion direction of the battery and/or with the shaft axis and/or the motor axis of the power tool, i.e. it can be parallel or collinear. However, other forms of fastening for the accessory device, in which the accessory device is mounted substantially perpendicularly to the motor axis and the shaft axis, are also conceivable.

It is preferred in the context of the invention that an accessory device is provided which can be connected to the power tool, the battery protection device and/or the battery protection elements. The accessory device preferably comprises a body, a soft supporting surface and connecting means, the body connecting the soft supporting surface and the connecting means to one another. When using the accessory device, the soft supporting surface faces the user of the power tool, so that the user of the power tool can support themselves on the soft supporting surface. The accessory device can be fastened to the power tool, the battery protection device and/or the battery protection elements with the connecting means. The supporting surface can be padded with foam or the like, for example, so that the user's pressure is distributed in a comfortable manner over as large an area as possible.

It is preferred in the context of the invention that the accessory device can be mounted on the battery protection device, with the soft supporting surface preferably being arranged on the side facing away from the power tool. The side of the accessory device facing away from the power tool preferably faces the user of the power tool, so that they can support themselves on this soft supporting surface of the accessory device when working with the power tool. As a result, the user can advantageously exert pressure on the power tool and achieve better work progress.

In addition, the accessory device can increase the average working time that a user can work with the power tool, especially when this work is carried out in a hand-held manner, i.e. without using a supporting drill stand. In addition, the protection for the energy supply device can be improved by the user no longer pressing against the battery itself during use of the accessory device, but rather against the soft and thus cushioning accessory device.

The energy supply device preferably has a substantially cuboidal body shape. In the context of the invention, this preferably means that the energy supply device has four corners on the right side and four corners on the left side: 1) top, front, 2) top, back, 3) bottom, front, and 4) bottom, back. It is preferred in the context of the invention that the protective device for the energy supply device or its battery protection elements are/is designed or arranged in such a way that at least one of these four corners on each side of the energy supply device is particularly well protected against the power tool falling over or being dropped. For this purpose, the battery protection elements can be arranged, for example, in such a way that in each case one battery protection element covers one corner of the energy supply device. In this way, the four corners of the power supply device of the power tool can be optimally protected with four battery protection elements on each side of the power tool.

In the configuration of the invention in which the drill stand interface is arranged on a top side of the power tool or on the side of the power tool, the second housing of the power tool can be offset downward in a spatial direction in an upward/downward direction in comparison to the first housing. In other words, the motor of the power tool and the energy supply device can be offset with respect to each other in terms of height. As a result, accessory material which is already present can advantageously continue to be used for carrying out drilling work if the drill stand interface is not arranged on the underside of the power tool, but if the drill stand interface is arranged on the side of the power tool or on the top side of the power tool instead.

Furthermore, in the context of the present invention, a system comprising a drill stand and a power tool is disclosed. The terms, definitions and technical advantages introduced for the power tool preferably apply analogously to the system.

### BRIEF DESCRIPTION OF THE DRAWINGS

Further advantages will become apparent from the following description of the figures. The figure, the description and the claims contain numerous features in combination. A person skilled in the art will expediently also consider the features individually and combine them to form sensible further combinations.

Identical and similar components are denoted by the same reference signs in the figure, In the figures:

FIG. 1 shows a view of a power tool with two housings located next to each other and a drill stand interface on the underside of the power tool

FIG. 2 shows a detailed view of the shaft axis A1 and the motor axis A2

FIG. 3 shows a side view of a power tool with two housings arranged offset with respect to each another, and with a rear handle

FIG. 4 shows a rear view of a power tool with two housings arranged offset with respect to each another, and with a lateral handle

FIG. 5 shows a side view of a system consisting of a power tool and a drill stand

FIG. 6 shows an oblique rear view of a power tool with two housings arranged offset with respect to each another, a side handle and a sensor

FIG. 7 shows a side view of a power tool with a second and a third handle (side handle and T handle)

FIG. 8 shows an oblique rear view of a power tool with a second and a third handle (side handle and T handle)

FIG. 9 shows a side view of a power tool with an inclined display device

FIG. 10 shows a rear view of a power tool with battery protection elements

FIG. 11 shows a view of one possible configuration of the power tool with an accessory device

FIG. 12 shows a schematic sectional illustration of one possible configuration of the accessory device

FIG. 13 shows a view of of one possible configuration of the power tool with an accessory device, the accessory device being mounted substantially perpendicularly to the shaft axis or motor axis.

### DETAILED DESCRIPTION

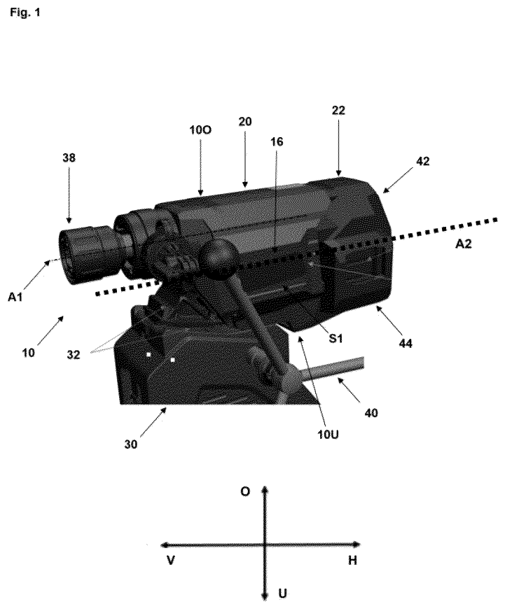

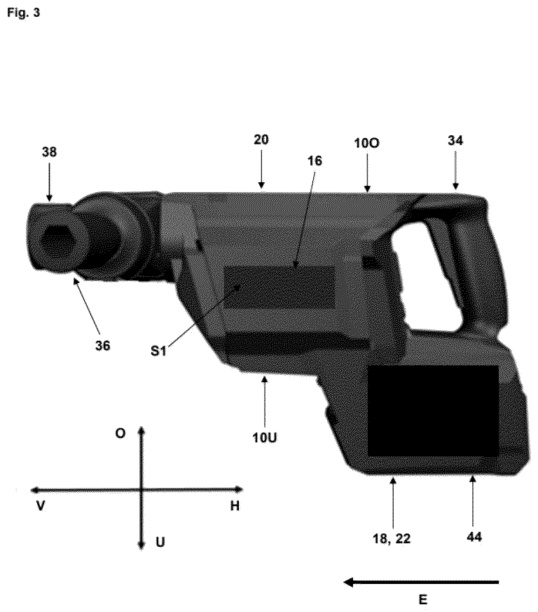

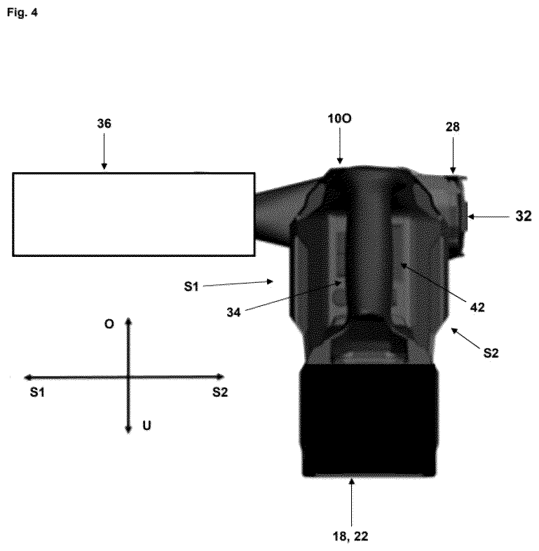

FIG. 1 shows a power tool 10 with a first housing 20 and a second housing 22, the two housings 20, 22 being arranged next to each another. In the context of the invention, this means that the first housing 20 and the second housing 22 are arranged substantially at the same height in relation to an upward/downward direction of the power tool 10. The upward/downward direction and a forward/rearward direction are shown in the figures by means of a directional cross. The upward/downward direction preferably runs between the “upward O” and “downward U” spatial directions, while the forward/rearward direction runs between the “forward V” and “rearward H” spatial directions. In other words, the upward/downward direction preferably extends between a top side 10O and an underside 10U of the power tool 10, while the forward/rearward direction extends between the tool fitting 38 of the exchangeable energy supply device 18. The tool fitting 38 preferably forms a front region of the power tool 10, while the exchangeable energy supply device 18 forms the rear region of the power tool 10. The side surfaces S1, S2 (see, e.g., FIG. 4) of the power tool 10 form the lateral boundaries of the housings 20, 22 of the power tool 10. FIGS. 1 and 3 in particular depict the left side S1 of the power tool 10, to which, for example, a lateral handle 36 can be fastened.

The power tool 10 shown in FIG. 1 has a drill stand interface 32 on the underside 10U of the power tool 10. In the power tool 10 depicted in FIG. 1, the at least one exchangeable energy supply device 18 is arranged in a continuation of the motor axis A2.

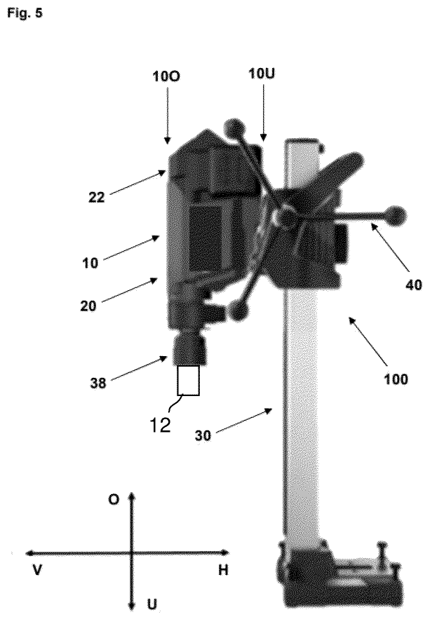

The power tool 10 illustrated in FIG. 1 is preferably designed as a purely stand-guided power tool 10, and therefore the power tool 10 preferably does not have any handles 34, 36. In other configurations of the invention, however, a purely stand-guided power tool 10 can also have handles, such handles being able to be provided, for example, for positioning the power tool 10 on a drill stand 30. The drill stand interface 32 serves to fasten the power tool 10 to a drill stand 30 (see FIG. 5). The power tool 10 depicted in FIG. 1 is designed as a core drill and has a drill bit as the tool 12 (see. e.g., FIG. 5). The tool 12 can be fastened to the power tool 10 with a tool fitting 38. The power tool 10 has a motor 16, the position of which within the power tool 10 can be described by a motor axis A2. The motor 16 has a motor shaft 24 and can generate a rotary movement, the rotary movement being able to be transmitted to the tool 12 by means of a shaft device 14. The position of the shaft device 14 within the power tool 10 can be described by a shaft axis A1. The shaft axis A1 preferably runs centrally through the shaft device 14 and the tool 12 of the power tool 10, with the shaft axis A1 preferably forming the drilling axis of the power tool 10. The motor axis A2 preferably runs centrally through the motor 16 of the power tool 10. The motor 16 is preferably in the form of an electric motor and preferably comprises a stator and a rotor.

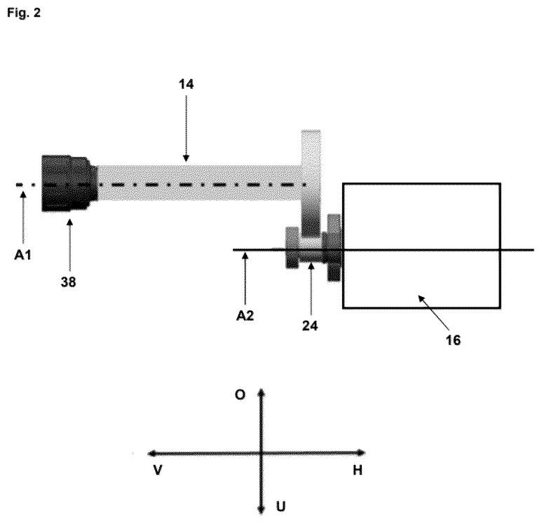

A detailed view of the shaft axis A1 and the motor axis A2 of the power tool 10 is depicted in FIG. 2.

The power tool 10 can be connected to at least one exchangeable energy supply device 18 for the purpose of supplying energy. For example, the power tool 10 can have a battery 18 or two batteries 18 as a rechargeable energy supply device 18. Rechargeable energy supply devices are preferably also referred to as “rechargeable batteries” in the context of the invention. The batteries 18 or rechargeable batteries 18 can be charged with a charger (not illustrated) when they have been depleted by the operation of the power tool 10. As an alternative to the batteries or rechargeable batteries, the exchangeable energy supply device 18 can be formed by a mains adapter. In this case, the power tool 10 can be supplied with electrical energy by means of the mains adapter 18. The mains adapter 18 can be connected to a power grid, such as a public power grid or a construction site power grid, via a power cord (not illustrated). The exchangeable energy supply device 18 can be connected to the power tool 10 via a receiving device (not illustrated) for the exchangeable energy supply device 18. In the context of the invention, said receiving device can preferably also be referred to as an “energy interface”. It is preferred in the context of the invention that the power tool 10 has a universal energy interface with which both batteries 18 and mains adapter 18 can be connected to the power tool 10. The energy supply device 18 can be inserted into a cavity of the power tool 10. The insertion preferably takes place in an insertion direction E.

The power tool 10 has a first housing 20 and a second housing 22. The first housing 20 at least partially encloses the motor 16 of the power tool 10, while the second housing 22 is configured to at least partially enclose the exchangeable energy supply device 18 of the power tool 10, in particular when the exchangeable energy supply device 18 is arranged in the power tool 10. According to the invention, the shaft axis A1 is substantially parallel to or collinear with the motor axis A2. In the power tool 10 illustrated in FIG. 1, the motor 16 and the exchangeable energy supply device 18 are arranged substantially at the same height with respect to an upward/downward direction of the power tool 10. The motor axis A2 runs below the shaft axis A1, with the motor axis A2 and the shaft axis A1 running substantially parallel to each another. The shaft device 14 is preferably configured to transmit a rotational movement of the motor 16 of the power tool 10 to the tool 12. The first housing 20 and the second housing 22 can also form housing regions of a superior housing, the first housing region 20, which preferably corresponds to the first housing 20, being configured to protect the motor 16 of the power tool 10, while the second housing region 22, which preferably corresponds to the second housing 22, is configured to protect the energy supply unit 18 of the power tool 10. FIGS. 1 to 10 in particular illustrate a two-part housing consisting of a first housing 20 and a second housing 22. However, the invention is not limited to a two-part housing 20,22; rather, the power tool 10 is also intended to be able to comprise a single-part housing. However, such a single-part housing can preferably comprise different functional housing regions, such as a motor housing region 20, for protecting the motor and/or a battery housing region 22 for protecting the energy supply device.

The drill stand 30 partially illustrated in FIG. 1 or in FIG. 5 has a handwheel with which a drilling feed can be transmitted to the power tool 10. The handwheel is preferably a feed device 40, with it being possible for the generation of the drilling feed to be preferably taken over by an automatic feed device. In the system 100 which is illustrated in FIG. 5 and consists of a power tool 10 and a drill stand 30, a drilling feed is generated in a “downward U” spatial direction and transmitted to the power tool 10. The tool fitting 38 of the power tool 10 (front region of the power tool 10) therefore points in the “downward U” spatial direction, while the exchangeable energy supply device 18 (rear region of the power tool 10) points in an “upward O” spatial direction. The drill stand interface 32 is present on the underside 10U of the power tool 10 in the power tool 10 illustrated in FIGS. 1 and 5. In the context of the invention, it is preferred that the feed device 40 can be used to generate a drilling feed in a “downward U” spatial direction. Said drilling feed is preferably directed in a forward direction V of the shaft axis A1.

FIG. 3 shows a side view of a power tool 10 with two housings 20, 22 offset with respect to each other, and with a rear handle 34. The wording that the first housing 20 and the second housing 22 are arranged offset with respect to each another preferably means, in the context of the invention, that the second housing 22 of the power tool 10 is offset in a “downward U” spatial direction in an upward/downward direction in comparison to the first housing 20. In the case of the power tool 10 shown in FIG. 3, the exchangeable energy supply device 18 and the second housing 22 are present below the first handle 34, which is preferably referred to as a rear handle 34. The motor 16 or the first housing 20 of the power tool 10 is arranged next to and in particular in front of the first handle 34. In other words, the motor 16 and the first housing 20 are arranged obliquely offset in the “upward O” and “forward V” spatial directions in relation to the exchangeable energy supply device 18 and the second housing 22. In this exemplary embodiment of the invention, the drill stand interface 32 is preferably arranged on a top side 10O or on the side walls S1, S2 of the power tool 10.

In the context of the invention, this preferably means that the drill stand interface 32 for fastening the power tool 10 to a drill stand 30 can be arranged, for example, laterally on the power tool 10. However, the drill stand interface 32 may also be arranged on a top side 10O of the power tool 10. The power tool 10 depicted in FIG. 3 can be used in a stand-guided and/or hand-held manner. In the context of the invention, this preferably means that the power tool 10 depicted in FIG. 3 is a universally usable power tool 10 which can be held in the hand of a user during operation or which can be fastened to a drill stand 30 during operation. The housings 20, 22 of the power tool 10 are illustrated in the figures in different contrasts or different colors or hatching.

The energy supply device 18 can be inserted into a cavity of the power tool 10. In this case, the insertion preferably takes place in an insertion direction E. In the exemplary embodiment of the invention shown in FIG. 3, the energy supply device 18 is introduced into the power tool 10 from the rear. The insertion direction E thus runs from a rear side of the power tool 10 in a forward V spatial direction. In the exemplary embodiment of the invention shown in FIG. 3, the insertion direction E runs substantially parallel to the shaft axis A1 and/or the motor axis A2.

FIG. 4 shows a rear view of a power tool 10 with two housings 20, 22 arranged offset with respect to each other, and with a side handle 36. The side handle 36 can preferably also be referred to as a “second or front handle” in the context of the invention. The exchangeable energy supply device 18 and the second housing 22 are illustrated in the lower, rear region of the power tool 10, while the rear handle 34 is illustrated above the exchangeable energy supply device 18.

FIG. 5 shows a side view of a system 100 consisting of a power tool 10 and a drill stand 30.

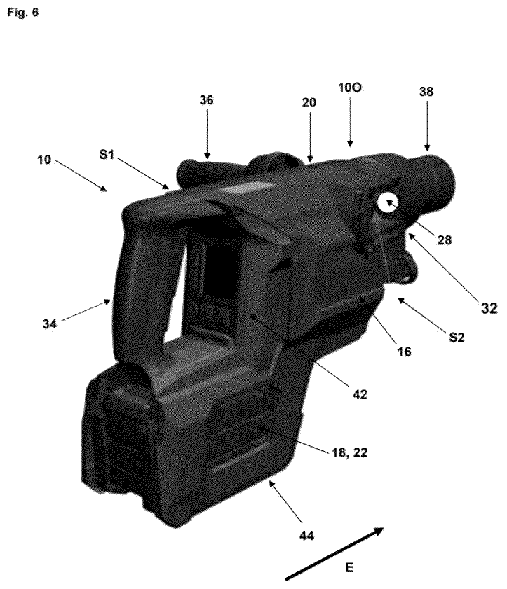

FIG. 6 shows an oblique rear view of a power tool 10 with two housings 20, 22 arranged offset with respect to each other, a side handle 36 (almost concealed) and a sensor 28 on the opposite side of the power tool 10. The power tool 10 depicted in FIG. 6 has a protective device 44 for the exchangeable energy supply device 18, and a display device 42. Different operating parameters, the connection state of the power tool 10 to a drill stand 30, motor characteristics or performance parameters can be displayed and/or set on the display device 42. The protective device 44 can surround the exchangeable energy supply device 18 and can be at least partially elastic in order to absorb impact forces in the event of dropping and to protect the exchangeable energy supply device 18 from damage. The at least one sensor 28 is configured to detect a connection state of the power tool 10 to a drill stand 30. Of course, the sensor 28 can be arranged at many different locations on the power tool 10. The sensor 28 can be integrated in the power tool 10 or, for example, can be subsequently fastened as a retrofit component to the power tool 10. It is preferred in the context of the invention that the sensor 28 is arranged in spatial proximity to the drill stand interface 32. The sensor 28 can preferably be integrated in the power tool 10. In alternative configurations of the invention, however, the sensor 28 can also be provided as a retrofit solution for the power tool 10.

FIG. 6 shows an oblique rear view of a power tool 10 with two housings 20, 22 arranged offset with respect to each other, a side handle 36 and a sensor 28. The sensor 28 can preferably be used to detect directly whether a power tool 10 is mounted on a drill stand 30. In other words, the sensor 28 can detect different connection states of the power tool 10, in particular whether a power tool 10 is arranged or is not arranged on the drill stand 30. The sensor 28 can be designed as a mechanical switch, proximity sensor and/or optical sensor. The sensor 28 can be configured to preferably automatically emit or send an installation signal when the power tool 10 is installed. In the event of removal of the power tool 10, the sensor 28 can be designed to emit or send a removal signal. For example, the signals can be output via optical output means such as displays or LEDs. However, in the context of the invention, it may also be preferred for the signals to be processed by information technology within the power tool 10 and/or used to control, display and/or adjust operating parameters. Advantageously, operating parameters or motor characteristics of the power tool 10 can be set or changed depending on a connection state of the power tool 10 to a drill stand 30. Said setting or adjustment or change preferably takes place automatically. For example, the power tool 10 can be controlled in a drill stand operating mode when the power tool 10 is arranged on a drill stand 30 and this is detected by the sensor 28. In addition, the power tool 10 can be controlled in a manual operating mode if the power tool 10 is held during its operation by a user's hand and this is detected by the sensor 28. The sensor 28 is preferably configured to detect an installation state on the drill stand 30. This means that the sensor 28 can detect whether the power tool 10 is mounted on a drill stand 30 (drill stand operating mode) or not. If the power tool 10 is not mounted on a drill stand 30, the power tool 10 can be operated in the manual operating mode, for example.

The exchangeable energy supply device 18, which is arranged in the second housing 22, can be seen clearly in FIG. 6. The exchangeable energy supply device 18 can be surrounded by a protective device 44 for the exchangeable energy supply device 18 to protect it against being dropped or against mechanical damage. In the exemplary embodiment of the invention 18 shown in FIG. 6, the energy supply device 18 can be inserted into the power tool 10 from behind; the insertion direction preferably runs from a rear side of the power tool 10 in a forward V spatial direction. Also in the exemplary embodiment of the invention shown in FIG. 6, the insertion direction E runs substantially parallel to the shaft axis A1 and/or the motor axis A2.

In addition, a display device 42 can be seen in the oblique rear view of the power tool 10 depicted in FIG. 6, which display device can have input and output means and is preferably arranged such that it can be easily seen by a user. The first, rear handle 34 is illustrated in the rear, upper region of the power tool 10, while the exchangeable energy supply device 18 is depicted in the rear, lower region of the power tool 10. In the power tool 10 illustrated in FIG. 6, the housings 20, 22 of the power tool 10 are offset with respect to each other both in an upward/downward direction and in a forward/rearward direction. In the context of the invention, this preferably means that the exchangeable energy supply device 18 and the second housing 22 are arranged in a rear, lower region of the power tool 10, while the motor 16 and the first housing 20 are arranged in a central, upper region of the power tool 10. The tool fitting 38 for the tool 12 of the power tool 10 is present in the front region of the power tool 10. The tool 12 can be driven by a shaft device 14, with the drilling axis A1 preferably running centrally within the shaft device 14 or centrally within the tool 12.

In the power tool 10 illustrated in FIG. 6, the sensor 28 is arranged on the right side S2 of the power tool 10, while the second, lateral handle 36 is arranged on the left side S1 of the power tool 10. It is preferred in the context of the invention for the sensor 28 and the drill stand interface 32 to be stationary and arranged in spatial proximity to each another on the power tool 10. The side handle 36 can be rotatable, for example. For example, the side handle 36 of the power tool 10 can be rotated by up to 360°. As a result, the operability of the power tool 10 can be significantly improved, for example for left-handers.

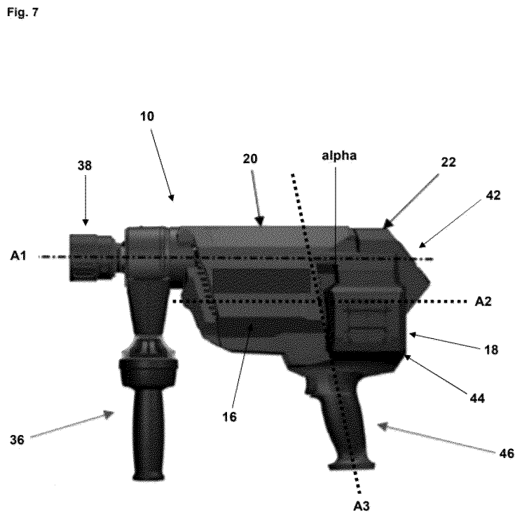

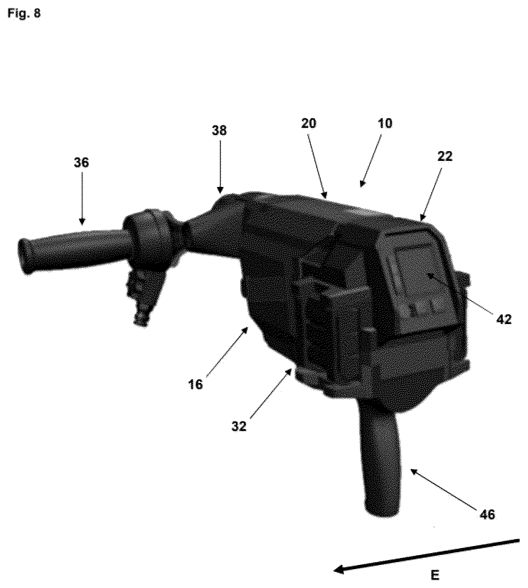

FIG. 7 shows a side view of a preferred embodiment of the power tool 10 with a second handle (side handle) 36 and a third handle (T handle) 46. FIG. 8 shows an oblique rear view of such a power tool 10. As can be seen from the different positions of the second handle 36 of the power tool 10, the second handle 36, which in the context of the invention is preferably also referred to as a side grip or side handle 36, can be rotatable, so that the second handle 36 can be rotated about a neck of the power tool 10. Complete rotatability of the second handle 36 by 360°, for example, is preferred. However, lesser rotatability may also be provided. Preferably, the shaft axis A1 can be considered to be the axis of rotation of the second handle 36. In other words, the second handle 36 can rotate about the shaft axis A1. In FIG. 7, the second handle 36 extends along an upward/downward direction of the power tool 10, so that the second handle 36 or an imaginary, virtual axis through the second handle 36, is substantially perpendicular to the shaft axis A1 or to the motor axis A2 running substantially parallel to or collinearly therewith. In the power tool 10 illustrated in FIG. 8, the second handle 36 is rotated by 90° in comparision to the position of the second handle 36 shown in FIG. 7, and therefore the second handle is oriented substantially horizontally in FIG. 8 and protrudes to the side of the power tool 10.

The third handle 46 is also arranged on the underside U of the power tool 10 in the power tool 10 illustrated in FIG. 7. A third axis A3 can be placed virtually through the third handle 46, said third axis enclosing an angle alpha with the shaft axis A1 and/or the motor axis A2. Angle alpha is shown in FIG. 7. The third axis A3 and the shaft axis A1 and/or the motor axis A2 enclose two opposite angles which add up to an angle sum of 180°. In the context of the invention, the angle alpha is preferably the smaller of the two opposite angles. The angle alpha can be, for example, about 80°, with it being preferred in the context of the invention that the angle alpha lies in a range from 60 to 100° or in a range from 70 to 90°. These angles advantageously lead to particularly ergonomic power tool postures, so that the power tool 10 can be used particularly gently and/or for long periods of time. In the power tool illustrated in FIG. 7, the second handle 36 and the third handle 46 lie in a plane which extends below the power tool 10. In the power tool 10 illustrated in FIG. 8, the second handle 36 and the third handle 46 are specifically not in the same plane; rather, the second handle 36 is rotated by 90° such that the second handle 36 is virtually perpendicular to said plane below the power tool 10. The display device 42, which can be provided on the rear side H of the power tool 10, is clearly visible in FIG. 8. The display device 42 is preferably embedded in the second housing 22 of the power tool 10.

The third handle 46 can be arranged below the first housing 20. Alternatively or additionally, the third handle 46 can be arranged below the second housing 22. In the context of the invention, it can be very particularly preferred that the third handle 46 is arranged below a transition region between the first housing 20 and the second housing 22. As a result, an ergonomically particularly well-balanced power tool 10 can be provided.

In the exemplary embodiment of the invention shown in FIG. 8, the insertion direction E of the energy supply device 18 runs substantially perpendicular to the shaft axis A1 and/or the motor axis A2. In the context of the invention, this preferably means that the energy supply device 18 can be introduced laterally into the power tool 10. The energy supply device 18 can preferably be introduced into the power tool 10 from right to left or from left to right. The energy supply device 18 can thus be installed in the power tool 10 transversely with respect to the shaft axis A1 and/or the motor axis A2. A battery axis can be defined, which preferably coincides with the insertion direction E and which, in the exemplary embodiment of the invention shown in FIG. 8, likewise runs perpendicularly or transversely with respect to the shaft axis A1 and/or the motor axis A2 of the power tool 10.

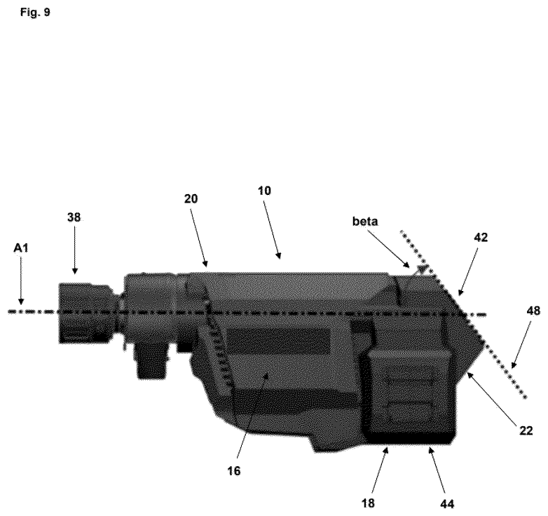

FIG. 9 shows a side view of a preferred configuration of a power tool 10 with an inclined display device 42. The display device 42 can be arranged on the rear side H of the power tool 10 and can be embedded in the second housing 22 of the power tool 10. The wording that the display device 42 can be “arranged at an inclination” preferably means in the context of the invention that a plane 48 in which the display device 42 lies encloses an angle beta with the shaft axis A1 and/or the motor axis A2, said angle beta being able to be in a range between 20 and 70°. The angle beta is shown in FIG. 9. The inclined arrangement of the display device 42 enables the display device 42 to be viewed particularly easily by a user and the information and data displayed can be detected in a particularly uncomplicated manner. The display device 42 is arranged in particular in such a way that it lies in the field of view of the user of the power tool 10.

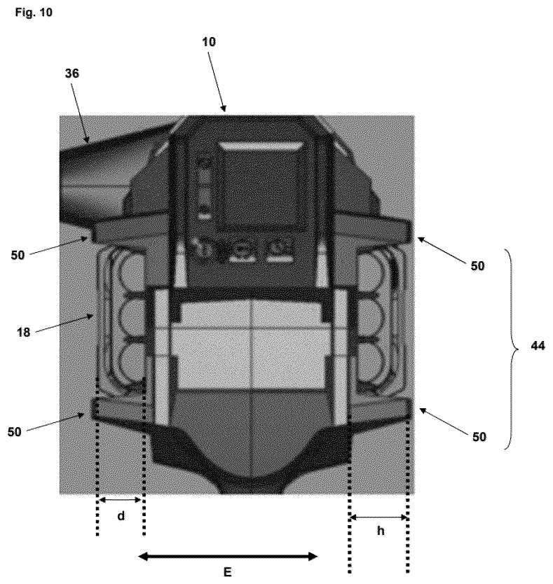

FIG. 10 shows a rear view of a preferred embodiment of a power tool 10 with battery protection elements 50. The battery protection elements 50 can form a protective device 44 for the energy supply device 18 of the power tool 10. The battery protection elements 50 can preferably be pillar-like, tapering elements that protrude from the housing 20, 22 of the power tool 10 in the manner of stalagmites or spikes. The battery protection elements 50 can have a height h that is greater than a protrusion d of the energy supply device 18 beyond the power tool 10. As a result, the corners of the energy supply device 18 of the power tool 10 can be protected particularly well against the power tool being dropped or falling over. The protrusion d is shown in FIG. 10. The protrusion d is preferably smaller than the height h of the battery protection elements: d<h in order to ensure optimal protection of the energy supply device 18 of the power tool 10.

Also in the exemplary embodiment of the invention shown in FIG. 10, the insertion direction E of the energy supply device 18 runs substantially perpendicularly or transversely with respect to the shaft axis A1 and/or the motor axis A2 of the power tool 10. As a result, the energy supply device 18 can advantageously be introduced laterally into the power tool 10 such that a particularly short and compact power tool 10 can be provided. The energy supply device 18 can preferably be introduced into the power tool 10 from right to left or from left to right, which is intended to be indicated by the arrow with the two arrowheads. The energy supply device 18 can be installed in the power tool 10 transversely with respect to the shaft axis A1 and/or the motor axis A2 such that a battery axis also runs perpendicularly or transversely with respect to the shaft axis A1 and/or the motor axis A2 of the power tool 10.

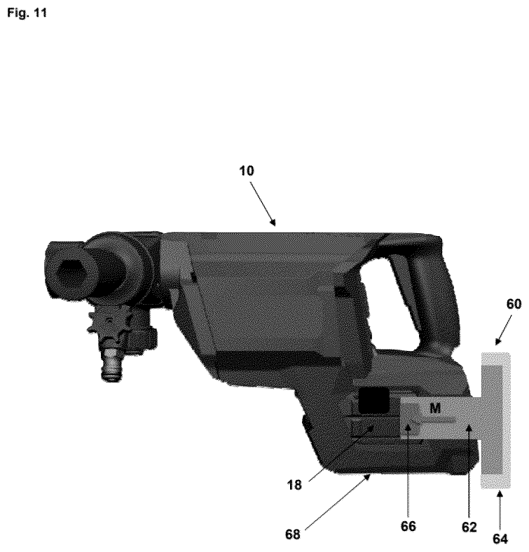

FIG. 11 shows one possible configuration of the power tool 10 with an accessory device 60. The accessory device 60 has a soft supporting surface 64 that faces the user of the power tool 10 when the user is working with the power tool 10. The supporting surface 64 can be arranged on a body 62, the body 62 also comprising connecting means 66 or being connected to said connecting means 66. The accessory device 60 can be fastened to the power tool 10, the protective device 44 (see, e.g, FIG. 6) for the energy supply device 18 and/or to the battery protection elements 50 (see, e.g, FIG. 10) by the connecting means 66. The energy supply device 18 can be surrounded by a battery surrounding device 68. The connecting means 66 can, for example, also encompass the battery surrounding device 68 and in this way establish a connection between the accessory device 60 and the power tool 10. The battery surrounding device 68 is preferably also used to protect the energy supply device 18 of the power tool 10.

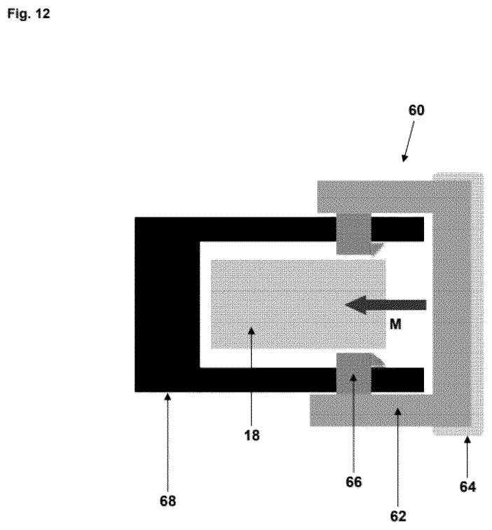

FIG. 12 shows a schematic sectional representation of one possible configuration of the accessory device 60. The energy supply device 18 and its battery surrounding device 68 can be seen in the left-hand half of the figure, while one possible configuration of the accessory device 60 is depicted in the right-hand half of the figure. In addition to the components of the accessory device 60, the mounting direction M of accessory device 60 is shown in particular, the mounting direction M in the exemplary embodiment of the accessory device 60 illustrated in FIG. 12 coinciding with the insertion direction E of the energy supply device 18.

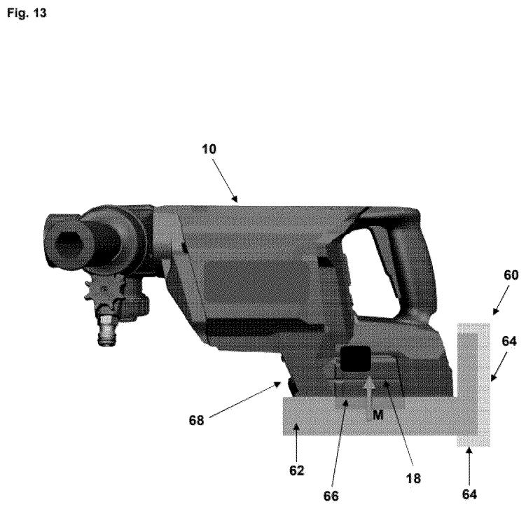

FIG. 13 shows one possible configuration of the power tool 10 with an accessory device 60, the accessory device 60 being mounted substantially perpendicularly to the shaft axis A1 or the motor axis A2 (see, e.g, FIG. 7).

### LIST OF REFERENCE SIGNS

10 Power tool
10U Underside of the power tool
10O Top side of the power tool
S1 First side of the power tool
S2 Second side of the power tool
12 Tool
14 Shaft device
16 Motor
18 Exchangeable energy supply device
20 First housing
22 Second housing
24 Motor shaft
28 Sensor
30 Drill stand
32 Drill stand interface
34 First/rear handle
36 Second/front handle, side handle
38 Tool fitting
40 Feed device
42 Display device
44 Protective device for energy supply device
46 Third handle
48 Display device plane
50 Battery protection elements
60 Accessory device
62 Body
64 Supporting surface
66 Connecting means of the accessory device
68 Battery surrounding device
100 System
A1 Shaft axis
A2 Motor axis
A3 Third axis through the third handle
M Mounting direction of the accessory device
alpha Angle between third axis and shaft axis and/or motor axis
beta Angle between display device plane and shaft axis and/or motor axis
d Protrusion
h Height of the battery protection elements
E Insertion direction
U Down, “downward” spatial direction
V Front, “forward” spatial direction
H Rear, “rearward” spatial direction
O Up, “upward” spatial direction

What is claimed is:

1-25. (canceled)

26. A power tool comprising:
a tool drivable by a shaft device; and
a motor, a position of the shaft device being defined by a shaft axis and a position of the motor being defined by a motor axis,
the power tool connectable to at least one exchangeable energy supply device in order to be supplied with energy, and the shaft axis running parallel to or collinearly with the motor axis.

27. The power tool as recited in claim 26 wherein the motor has a motor shaft, the motor axis defined by the motor shaft.

28. The power tool as recited in claim 26 further comprising a first housing and a second housing, the first housing being configured to at least partially enclose the motor, and the second housing being configured to at least partially enclose the exchangeable energy supply device.

29. The power tool as recited in claim 26 further comprising a receiver for receiving the at least one exchangeable energy supply device.

30. The power tool as recited in claim 29 further comprising a first housing and a second housing, the first housing being configured to at least partially enclose the motor, and the second housing being configured to at least partially enclose the exchangeable energy supply device, the receiver being arranged in the second housing.

31. The power tool as recited in claim 26 wherein the shaft axis or the motor axis is arranged in a forward/rearward direction of the power tool.

32. The power tool as recited in claim 26 wherein the energy supply device is insertable into the power tool along an insertion direction.

33. The power tool as recited in claim 32 wherein the insertion direction is oriented parallel to the shaft axis and the motor axis.

34. The power tool as recited in claim 32 wherein the insertion direction is oriented perpendicular to the shaft axis and the motor axis.

35. The power tool as recited in claim 26 further comprising at least one sensor for detecting a connection state of the power tool to a drill stand.

36. The power tool as recited in claim 26 further comprising a drill stand interface for connecting the power tool to a drill stand.

37. The power tool as recited in claim 36 wherein the drill stand interface is arranged on an underside of the power tool.

38. The power tool as recited in claim 36 wherein the at least one exchangeable energy supply device is arranged in a continuation of the shaft axis or motor axis.

39. The power tool as recited in claim 36 wherein the drill stand interface is arranged on a top side of the power tool.

40. The power tool as recited in claim 36 wherein the drill stand interface is arranged on a first side wall or on a second side wall of the power tool.

41. The power tool as recited in claim 28 wherein the second housing of the power tool is offset downward in a spatial direction in an upward/downward direction in comparison to the first housing.

42. The power tool as recited in claim 26 further comprising a second handle, the second handle being rotatable.

43. The power tool as recited in claim 26 further comprising a display device, the display device being arranged at an inclination.

44. The power tool as recited in claim 43 wherein the display device is embedded in an inclined display device plane.

45. The power tool as recited in claim 42 further comprising a third handle designed as a T handle.

46. The power tool as recited in claim 45 wherein the third handle is inclined.

47. The power tool as recited in claim 26 further comprising a protective device with battery protection elements.

48. The power tool as recited in claim 47 further comprising a first housing and a second housing, the first housing being configured to at least partially enclose the motor, and the second housing being configured to at least partially enclose the exchangeable energy supply device and wherein the battery protection elements protrude from the first housing or the second housing of the power tool.

49. The power tool as recited in claim 47 wherein the battery protection elements have a height greater than a protrusion of the energy supply device.

50. The power tool as recited in claim 26 wherein the power tool is connectable to an accessory by a connector, the accessory having a body and a supporting surface, the supporting surface being designed such that a user of the power tool can support themselves on the supporting surface.
